(19) United States
(12) Patent Application Publication
(10) Pub. No.: US 2007/0056444 A1
(43) Pub. Date: Mar. 15, 2007

(54) Electronic Enclosure Filter Containing Fluted Media

(76) Inventor: Vijay K. Garikipati, Eagan, MN (US)

Correspondence Address: PAULY, DEVRIES SMITH & DEFFNER, L.L.C., P.O. BOX 2960, MINNEAPOLIS, MN, 55402-2960, US

(21) Appl. No.: 11/457,085

(22) Filed: Jul. 12, 2006

Related U.S. Application Data
(60) Provisional application No. 60/698,655, filed on Jul. 12, 2005.

(51) Int. Cl. B01D 53/02

(52) U.S. Cl. 96/135

(57) ABSTRACT

A filter for removing contaminants from an electronic enclosure. The filter includes fluted filter media for increasing the filter surface area. The filter may be configured in a flow by configuration or a flow through configuration. The filter may further include a scrim. A disk drive assembly includes an enclosure, a disk rotatably mounted within the enclosure, and a filter, where the filter is constructed from fluted filter media.

### PRIORITY

This application claims the benefit of U.S. Provisional Patent Application Ser. No. 60,698,655, filed Jul. 12, 2005, which application is hereby incorporated by reference in its entirety.

### FIELD OF THE INVENTION

The invention relates to recirculation filters for use in electronic enclosures, such as disk drives.

### BACKGROUND OF THE INVENTION

Hard disk drives and other electronic equipment are often sealed within enclosures to provide a clean environment that is necessary for optimal operation of the equipment. For example, typical hard disk drives include enclosures in which an inflexible platter coated with magnetic material is very rapidly spun. A magnetic read/write head “flies” only a few microns above the disk on an air cushion. To provide a hard disk drive having high efficiency, it is desirable to position the head as close to the disk as possible without touching it.

It has been found that particulate and gaseous contaminants act to reduce efficiency and longevity of hard disk drives. These contaminants can gradually damage the drive, cause deterioration in performance, and in certain situations can even cause sudden, complete failure of it. Common sources of contaminants in disk drives include leaks, which may or may not be intentional, the manufacturing environment which can contain certain contaminants, and the materials incorporated into the disk drive which give off particulates and gases.

A particular concern regarding electronic enclosures is that organic vapors and other contaminants, including particulates, can be generated inside electronic enclosures during normal operating conditions. For example, when the temperature exceeds 150° F., organic acids and organic vapors can be formed that damage electronic components. Such temperatures can be achieved by simply leaving the computer in the trunk of a car on a hot day. It is important that these contaminants generated within the enclosure be efficiently captured or removed in order to prevent deterioration of the electronic equipment.

Recirculation filters have been used in hard disk drives and other electronic enclosures for removing contaminates, and such filters have been effective for removing particulate contaminants. Some recirculation filters have included electrostatic media designed to collect and retain particulate contamination. However, a need exists for improved recirculation filters, and improved filter media, for use in electronic enclosures.

### SUMMARY OF THE INVENTION

The present invention is directed to a filter for use inside of an electronic enclosure, such as a hard disk drive enclosure containing a rotating disk. The filter is constructed from filter media and has at least one exposed surface, where the filter media is fluted on the at least one exposed surface.

The present invention is also directed to a disk drive assembly, where the assembly includes an enclosure, a disk rotatably mounted within the enclosure, and a filter constructed from a filter media having at least one exposed surface, the filter media having flutes on the at least one exposed surface.

### BRIEF DESCRIPTION OF THE DRAWINGS

The invention may be more completely understood in connection with the following drawings, in which:

FIG. 1 is a top view of a filter constructed according to the principles of the present invention.

FIG. 2 is a top view of a second embodiment of a filter constructed according to the principles of the present invention.

FIG. 3 is a perspective view of a filter according to the present invention configured in a flow-by orientation relative to an air current.

FIG. 4 is a perspective view of a filter according to the present invention configured in a flow through orientation relative to an air current.

### DESCRIPTION OF THE INVENTION

The present invention is directed to filter media and a filter construction for placement within a disk drive enclosure, or other electronic enclosure, that is configured to remove physical contaminants, e.g., particulates, from air within the enclosure. The filter media and construction of the present invention provides improved contaminant capturing effectiveness, including better efficiency when challenged with smaller particles, and faster contaminant clean up times. This improved performance is becoming increasingly important as the “fly-height” of the disk drive read-write head above the disk decreases.

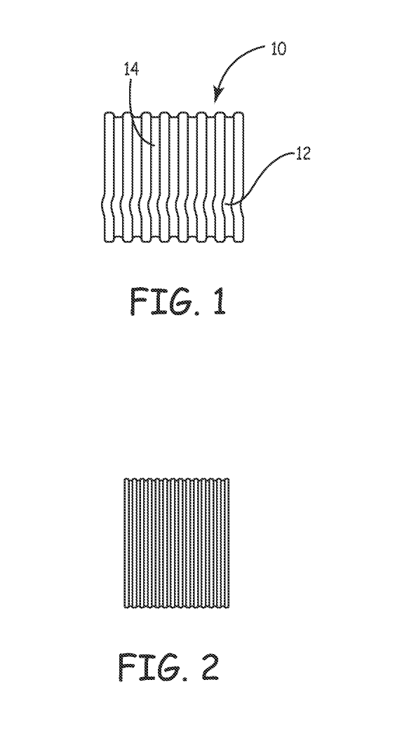

The filter media of the present invention incorporates flutes for increasing the surface area of the filter media that is exposed within the electronic enclosure. Flutes may be characterized as grooves, furrows, or ripples on at least one surface of the filter media. A filter constructed according to the principles of the present invention is depicted in FIG. 1. In general, filter 10 is constructed from filter media and has a first, exposed surface 14 and a second, opposite surface 16. In one embodiment, surface 16 is in contact with and attached to an electronic enclosure, for example, by way of adhesive. Exposed surface 14 is exposed to the air and gases present within the electronic enclosure.

Surface 14 incorporates flutes 12 to increase the surface area of filter 10 that is exposed to the air and gases present within the electronic enclosure. The increased surface area of filter 10 improves contaminant capture efficiency and improves contaminant clean up times. There are many usable embodiments of flutes 12. In one embodiment, surface 14 comprises a corrugated layer of filter media forming flutes 12. In another embodiment, surface 14 comprises a series of grooves or furrows cut or formed into surface 14 to form flutes 12. In yet another embodiment, surface 14 comprises a pleated layer of filter media to form flutes 12.

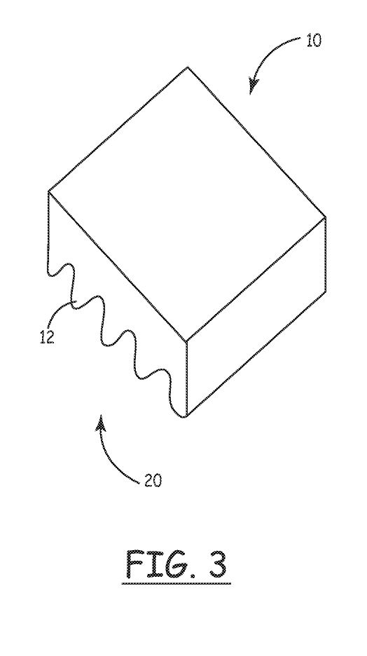

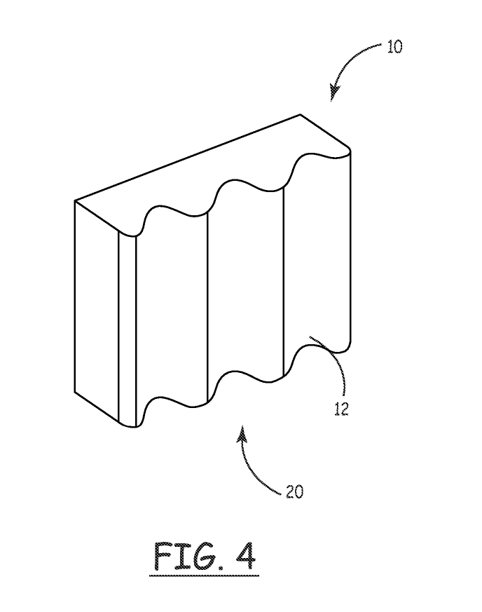

In an electronic enclosure such as a disk drive, air currents are generated as a result of the rotating action of the disk. In general, at any point within the enclosure these air currents move in a direction approximately perpendicular to a radius of the disk (i.e., in a swirling motion about the disk). Flutes 12 can be configured to engage with these air currents in a particular orientation. For example, flutes 12 can be configured in either a flow-by mode or a flow-through mode. In a flow-by mode, depicted in FIG. 3, the air currents 20 flow by flutes 12, such that air currents 20 flow alongside flutes 12. In flow by mode, flutes 12 may be configured at any angle with respect to the air current. In a flow through mode, depicted in FIG. 4, the air currents 20 flow through flutes 12. In this configuration, filter 10 is typically perpendicular to the air current 20, but the filter 10 may be configured at any angle with respect to air current 20.

Flutes 12 have a height, which is the distance from the base of a flute to the peak. The flutes 12 also have a width, which is the distance from a fixed position on one flute to the corresponding position on an adjacent flute. For example, the flute width could be measured as the distance from the peak of one flute to the peak of the adjacent flute. The flutes may also be characterized by a flute density, which is the number of flutes in a given distance, which is an equivalent measure to the width of one flute. The flutes 12 can have a height greater than 1 mm and a width greater than 1 mm, but are generally less than 1 mm in height and width. FIG. 1 and FIG. 2 show photographs of two example embodiments. The flutes provide an increased media surface area, and thereby provide increased contaminant capture efficiency. Generally, increasing the flute height and flute density increases the media surface area and in doing so increases the contaminant capture efficiency.

Filter 10 can be constructed from a variety of media known to those of skill in the art. In one embodiment, the construction of filter 10 can further include a scrim covering layer 18. In yet another embodiment, the construction of filter 10 can include an adsorbent.

In the flow-by mode, the fluted filter media 10 can be adhered to the cover or base of an electronic enclosure using, for example, a pressure sensitive adhesive. The fluted filter media 10 can include two or more layers, with a lower scrim layer adhered to an upper particulate media, such as an electrostatic media. In the flow-through mode, the fluted filter 10 generally includes a scrim 18 along with particulate media.

The particulate filter removes and retains particulate contaminants. The particulate filter can be, for example, a polymeric material containing an electrostatic composition. The particulate filter may include a porous polymer film made from, for example, polyethylene, polypropylene, polytetrafluoroethylene, or expanded polytetrafluoroethylene. The particulate filter may optionally include a woven or nonwoven scrim or support layer to support the porous polymer film.

The present invention is also directed to a disk drive assembly having a filter construction therein. Such a disk drive assembly comprises an enclosure, a disk rotatably mounted within the enclosure, and a filter 10 constructed according to the principles of the present invention.

A method of removing contaminants from a disk drive assembly is also disclosed. The method includes positioning a filter 10 according to the present invention at least partially within a disk drive assembly. The method further includes filtering an internal air current with the filter 10, the internal air current moving within the disk drive assembly.

What is claimed is:

1. A filter media for an electronic enclosure comprising:
a filter media having at least one exposed surface, said filter media having flutes on said at least one exposed surface.

2. The filter media of claim 1, wherein the flutes comprise corrugations.

3. The filter media of claim 1, wherein the flutes comprise furrows formed in the filter media.

4. The filter media of claim 1, wherein the flute width is 1 mm or less.

5. The filter media of claim 1, wherein the flute height is 1 mm or less.

6. The filter media of claim 1, wherein the filter media is configured for flow by orientation relative to an air current.

7. The filter media of claim 1, wherein the filter media is configured for flow through orientation relative to an air current.

8. The filter media of claim 1, further comprising a scrim covering layer.

9. A disk drive assembly comprising
an enclosure;
a disk rotatably mounted within the enclosure; and
a filter constructed from a filter media having at least one exposed surface, said filter media having flutes on said at least one exposed surface.

10. A method of removing contaminants from a disk drive assembly comprising:
providing an enclosure and a disk rotatably mounted within the enclosure;
providing a filter media within the enclosure, said filter media having at least one exposed surface, said filter media having flutes on said at least one exposed surface;
rotating said disk so as to generate an air current within said enclosure; and
filtering contaminants from said air current with said filter media.
